(19) United States
(12) Patent Application Publication
(10) Pub. No.: US 2018/0336397 A1
(43) Pub. Date: Nov. 22, 2018

(54) METHOD FOR DETECTING A LIVE FACE FOR ACCESS TO AN ELECTRONIC DEVICE

(71) Applicant: Tandent Vision Science, Inc., San Francisco, CA (US)

(72) Inventor: Casey Arthur Smith, Grand Junction, CO (US)

(21) Appl. No.: 15/597,797

(22) Filed: May 17, 2017

(51) Int. Cl. G06K 9/00; G06K 9/20; G06K 9/62; G06K 9/46

(52) U.S. Cl. CPC G06K 9/00288; G06K 9/00228; G06K 9/2027; G06K 2009/4666; G06K 9/4652; G06K 9/4661; G06K 9/00906; G06K 9/6215

(57) ABSTRACT

An exemplary method is provided for operating an electronic device to detect a live face, so as to distinguish an actual authorized user from an image of the authorized user. The method comprises the steps of using the electronic device to capture multiple images of an object, with at least one of the captured images including added illumination of a selected color, identifying pixels of the captured images corresponding to each of an identified shaded region and an identified lit region of the object, comparing the pixels corresponding to the identified shaded and lit regions of the object from each of the multiple images, to each other, to determine a dark and lit region relative color or intensity difference and detecting a three-dimensional object in the images as a function of the dark and lit region relative color or intensity difference. The electronic device enables or confirms a face recognition function to determine an authorized user when the detection indicates a three-dimensional object.

### BACKGROUND OF THE INVENTION

Secure access to an electronic device such as a smart phone, tablet, laptop computer or desktop computer, is an important, critical design feature. Typically, an authorized user of, for example, a smart phone enters a password on the phone keyboard to obtain access to the functions and information available on the phone. In recent years efforts have been made to simplify the access procedure, while also increasing security. For example, a face recognition algorithm is utilized to recognize the face of an authorized user. However, a problem with face recognition is that an unauthorized user can obtain access by using an image, such as a photograph, of the authorized user, to access the functions and information available on the electronic device.

### SUMMARY OF THE INVENTION

The present invention provides a method for operating an electronic device to detect a live face, so as to distinguish an actual authorized user from an image of the authorized user.

In a first exemplary embodiment of the present invention, an automated, computerized method for processing images of an object to detect a three-dimensional object is provided for use on an electronic device. According to a feature of the present invention, the method comprises the steps of using the device to capture multiple images of an object, with at least one of the captured images including added illumination of a selected color, identifying pixels of the captured images corresponding to each of an identified shaded region and an identified lit region of the object, comparing the pixels corresponding to the identified shaded and lit regions of the object from each of the multiple images to each other, to determine a dark and lit region relative color difference and detecting a three-dimensional object in the images as a function of the dark and lit region relative color difference.

In a second exemplary embodiment of the present invention, an automated, computerized method for processing images of an object to detect a three-dimensional object is provided for use on an electronic device. According to a feature of the present invention, the method comprises the steps of capturing multiple images of an object having identified dark and lit regions, with at least one of the images being captured with added illumination, relative to others of the multiple images, and detecting a three-dimensional object as a function of a difference between pixel characteristics of the multiple images relative to the identified dark and lit regions.

According to a feature of the exemplary embodiments of the present invention, the electronic device enables or confirms a face recognition function to determine an authorized user when the detection indicates a three-dimensional object.

According to the present invention a computer readable media is contemplated as being any non-transitory product that embodies information usable in a programable device, such as a smart phone, to execute the process steps of the present invention, including, for example, information written on a non-transitory media readable by a computer, and downloaded by the programmable device for execution, or transmitted to a programmable device via the interne, for execution, or instructions implemented as a hardware circuit, for example, as in an integrated circuit chip.

### BRIEF DESCRIPTION OF THE DRAWINGS

FIG. 1a is a diagram illustrating a smart phone recording a figure representing a three-dimensional, live human face.

FIG. 1b is a diagram illustrating a smart phone recording a figure representing a two-dimensional photograph of the human face of FIG. 1a.

FIG. 1c is a diagram illustrating a smart phone recording a figure representing a two-dimensional electronic image display of the human face of FIG. 1a.

FIG. 2 is a flow chart for distinguishing a three-dimensional object from a two-dimensional image of the object, according to a first exemplary embodiment of the present invention.

FIG. 3 is a flow chart for distinguishing a three-dimensional object from a two-dimensional image of the object, according to a second exemplary embodiment of the present invention.

FIG. 4 is a flow chart for distinguishing a three-dimensional object from a two-dimensional image of the object, according to a third exemplary embodiment of the present invention.

FIG. 5a shows a log RGB graph depicting color values of pixels for each of a first picture and a second picture of a two-dimensional object.

FIG. 5b shows a log RGB graph depicting color values of pixels for each of a first picture and a second picture of a three-dimensional object.

### DETAILED DESCRIPTION OF THE PREFERRED EMBODIMENTS

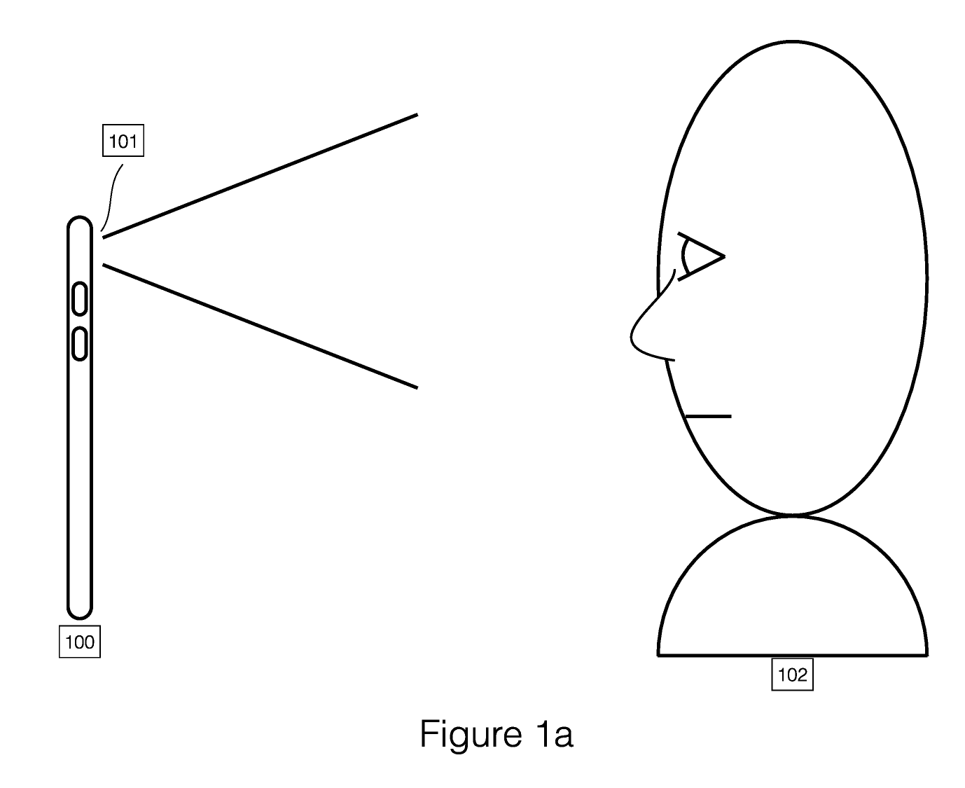

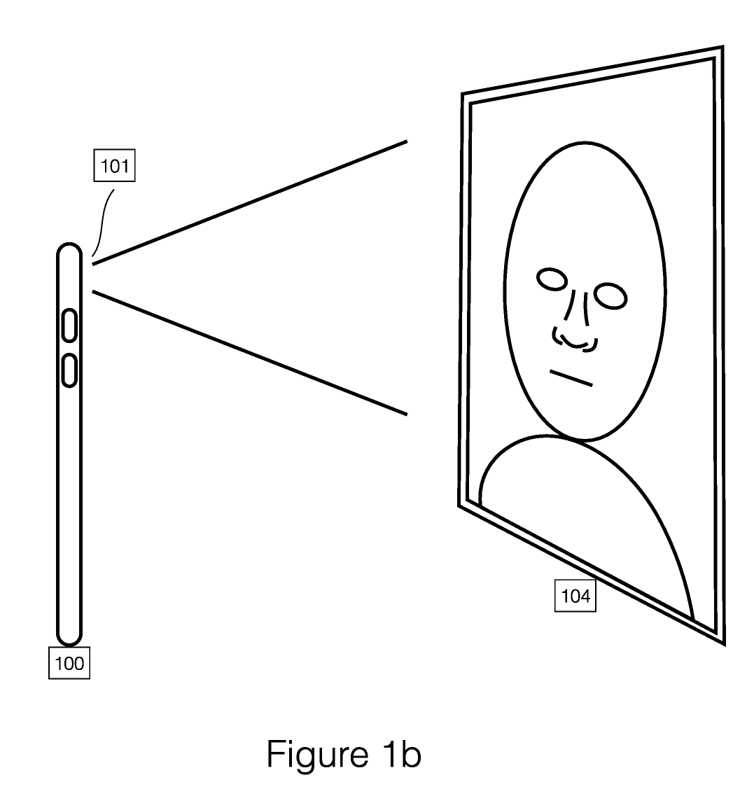

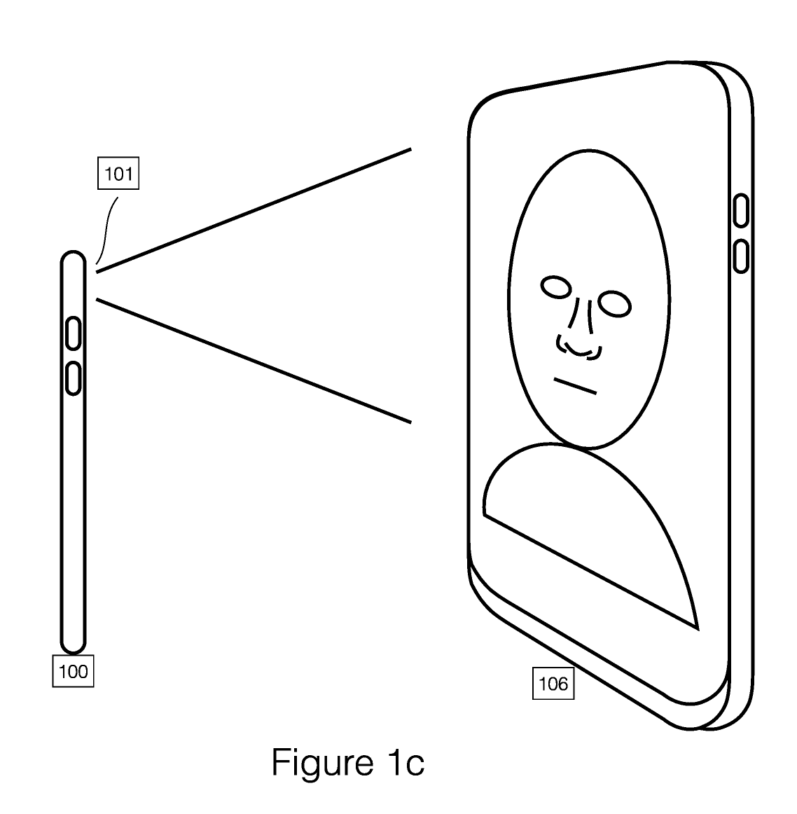

Referring now to the drawings, and initially to FIG. 1a, there is shown a diagram illustrating an electronic device, for example, a smart phone recording a figure representing a three-dimensional, live human face. In the diagram, a commercially available smart phone 100 is equipped with an on-board camera 101, as is well known. The smart phone 100 is designed to utilize the on-board camera 101 to record an image of an authorized user 102, and enable access to the functions and information available on the smart phone 100 when an installed, known face recognition application confirms that the recorded image is that of the authorized user 102.

However, as shown in FIGS. 1b and 1c, the security function of the face recognition feature can be compromised when a two-dimensional image of the authorized user is presented to the smart phone 100 for recording by the on-board camera 101. As shown in FIG. 1b, a two-dimensional photograph 104 of the authorized user 102 is recorded by the smart phone 100. Again, as shown in FIG. 1c, a two-dimensional electronic image display 106 of the authorized user 102 is recorded by the smart phone 100. Access will be granted unless the two-dimensional image can be detected by the smart phone 100.

According to a feature of the present invention, a pixel color or intensity analysis is performed, by the processor installed on an electronic device such as, for example, the smart phone 100, on images recorded by the smart phone 100, to distinguish between three-dimensional and two -dimensional objects, to thereby verify that a face presented for recognition as an authorized user is actually a live, three-dimensional face rather than a two-dimensional image of the face. As known, each image captured by the on-board camera 101 comprises an array of pixels, to provide a picture of the recorded object.

Pursuant to the teachings of the present invention, it is recognized that a human face is a three-dimensional object that is typically shaded by illumination. Only under rare, extremely controlled illumination conditions would the human face be unshaded. Thus, the existence of differing color and/or intensity characteristics in typically shaded and unshaded areas of a human face can be analyzed to confirm the three-dimensional nature of an object presented for recording by the on-board camera 101.

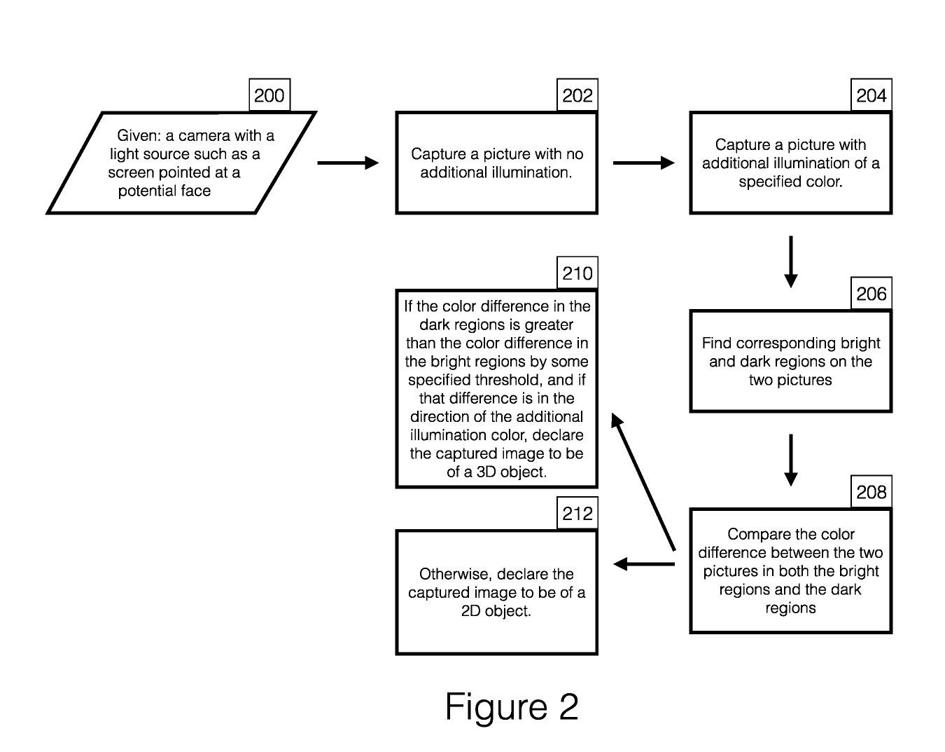

Referring now to FIG. 2, there is shown a flow chart for distinguishing a three-dimensional object from a two-dimensional image of the object, according to a first exemplary embodiment of the present invention. As noted above, the smart phone 100 is equipped with an on-board camera 101 (step 200). Pursuant to the first exemplary embodiment of the present invention, a computer program is executed by a processor installed on the smart phone 100, to operate the on-board camera 101, to capture a first picture of an object presented as an authorized user with no additional illumination (step 202) and then capture a second picture of the same object with additional illumination of a pre-selected, specified color (step 204).

According to a feature of the present invention, the screen of the smart phone 100 can be utilized to emit the additional illumination while the on-board camera 101 captures the second picture of the object. Alternatively, an LED can be installed in the front of the smart phone 100, to emit the additional illumination. The LED can emit a colored illumination, for example red. To make the entire picture capture invisible to the user, a near infra-red camera and near infra-red illumination emitter can be used to capture the first and second pictures.

From observation, it is known that skin areas of a human face around the eyes and at the bottom of the nose receive less illumination than, for example, skin areas of the cheeks and/or forehead. Thus, in step 206, the processor of the smart phone 100 is operated, according to the computer program, to identify pixels in each of the first and second pictures, with the pixels corresponding to skin areas around the eyes and/or at the bottom of the nose, designated as a known or identified dark or shaded region, and pixels corresponding to skin areas of the cheeks or forehead, designated as a known or identified bright or lit region. Known face detection techniques can be implemented to identify the eye, nose, forehead and cheek areas of a face image.

Alternatively, in step 206, the face detection techniques can be implemented to identify dark and lit regions by first identifying skin regions of the image, and then analyze pixels of the skin regions to further identify relatively bright and dark regions of the skin. For example, all pixels in the 2^{nd} through 5^{th} percentile of the pixel intensity range can be designated as an identified dark or shaded region, and all pixels in the 90^{th} to 95^{th} percentile of the intensity range can be designated as an identified lit or bright region.

In step 208, the processor of the smart phone 100 operates to compare pixel color differences between the dark or shaded regions of the two different pictures of the object recorded in steps 202 and 204. The processor of the smart phone 100 also operates to compare pixel color differences between the bright or lit regions of the two different pictures of the object recorded in steps 202 and 204.

According to a feature of the present invention, the comparison of step 208 is performed by subtracting the pixel color value of the dark region in the picture of step 202 from the pixel color value in the dark region of the picture of step 204, and dividing the subtraction result by pixel color value of the dark region of the picture of step 202 to determine the percentage color change in the dark region between the pictures of steps 202 and 204. Then, also subtracting the pixel color value of the bright region in the picture of step 202 from the pixel color value in the bright region of the picture of step 204, and dividing the subtraction result by pixel color value of the bright region of the picture of step 202 to determine the percentage color change in the bright region between the pictures of steps 202 and 204. When the percentage color change for the dark region is greater than the percentage color change for the bright region by a pre-selected threshold, and when the greater change is in the direction of the added illumination color, then the processor detects a three-dimensional object.

An alternative comparison can be executed by comparing, in a linear color space, a ratio defined by pixel color values for a dark region divided by the pixel color values for a bright region, from the picture of step 202, to a ratio of the pixel color values for the dark region divided by the pixel color values for the bright region, from the picture of step 204. When the ratio in the picture of step 204 is significantly more similar to the added illumination color than the ratio for the picture of step 202, that indicates that the pixels of the dark region have a more significant color change than the pixels of the bright region. Then the processor detects a three-dimensional image.

In any case, when the comparison of step 208 shows a greater color difference between pixels of the dark regions of the two pictures than the color difference between pixels of the bright regions of the two pictures, relative to a pre-selected threshold value, and the color difference is in the direction of the color of the additional illumination added in the picture capture of step 204, then the processor can detect that the object being recorded is a three-dimensional object, and enable or confirm a face recognition task operated to verify an authorized user (step 210).

Otherwise, the processor indicates a detection that the object being recorded is a two-dimensional image, and denies access to the smart phone (step 212).

A color difference analysis according to the present invention is based upon a physical difference between a three-dimensional object and a two-dimensional image of the object. When the light cast upon a three-dimensional object is changed, as between the two pictures in steps 202 and 204, color relationships vary relative to shaded and lit regions of the three-dimensional surface being recorded. However, in a two-dimensional surface of an image of the three-dimensional object, there are no actual shaded and lit areas, just different material reflective properties on the two-dimensional surface, so color relationships remain relatively constant. The basic insight recognized by the present invention is that adding colored fill light to a three-dimensional object being recorded, as, for example, between the pictures recorded in steps 202 and 204, changes color more in shadowed areas, such as skin areas around the eyes and at the bottom of the nose, than in better lit areas, such as skin areas of the cheeks and forehead of a three-dimensional human face. For example, when green light is added in the second picture (step 204), the pixels of the dark region increase more in the green band than pixels in the bright region when the object being recorded is a three-dimensional object. When the object is a two-dimensional photograph, the apparently shaded areas are actually simply printed darker and are under the same illumination as the apparently lit areas of the photograph. Adding green light changes the color of each of the shaded and lit depictions of the photograph equally.

Similarly, in a two-dimensional video or photograph displayed on the screen of another smart phone, tablet or similar electronic device, as shown in FIG. 1c, screen colors between depictions of shadowed and lit areas of the image are largely unaffected by additional colored illumination.

Thus, there is a dark and lit region relative color difference for skin surfaces of a three-dimensional face, as between the pictures captured in steps 202 and 204, that can be used to determine a three-dimensional object, as performed in steps 208, 210 and 212.

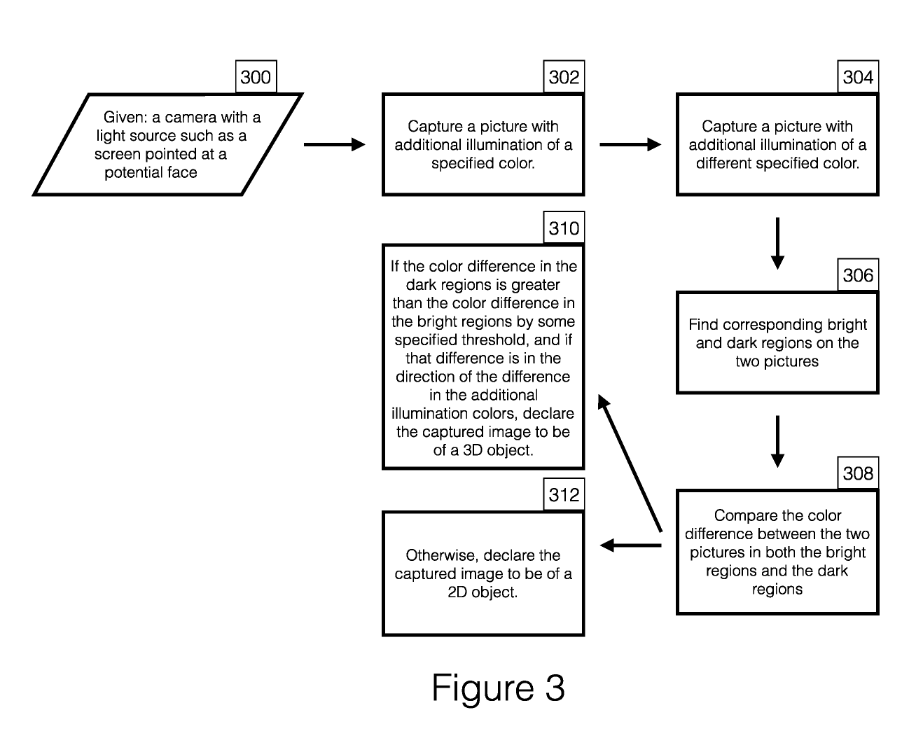

Referring now to FIG. 3, there is shown a flow chart for distinguishing a three-dimensional object from a two-dimensional image of the object, according to a second exemplary embodiment of the present invention. As in the first exemplary embodiment, in step 300, the smart phone 100 is equipped with an on-board camera 101. Pursuant to the second exemplary embodiment of the present invention, a computer program is executed by a processor installed on the smart phone 100, to operate the on-board camera 101, to capture a first picture of an object presented as an authorized user with additional illumination of a first specified color (step 302) and then capture a second picture of the same object with additional illumination of a second, different specified color (step 304).

In step 306, the processor of the smart phone 100 is operated, according to the computer program, to identify pixels corresponding to skin areas around the eyes and/or at the bottom of the nose, as a dark region, and pixels corresponding to skin areas of the cheeks and/or forehead, as a bright region. In the alternative, the processor can identify skin pixels and then identify corresponding dark and bright regions of the skin pixels. As in the first exemplary embodiment of the present invention, known face detection techniques can be implemented to identify the eye, nose and cheek areas of a face image.

In step 308, the processor of the smart phone 100 operates to compare pixel color differences between the dark regions of the two different pictures of the object recorded in steps 302 and 304. The processor of the smart phone 100 also operates to compare pixel color differences between the bright regions of the two different pictures of the object recorded in steps 302 and 304. Step 308 can be implemented using any of the comparison methods described above, in respect to the first exemplary embodiment of the present invention.

When the comparison of step 308 shows a greater color difference between pixels of the dark regions of the two pictures than the color difference between pixels of the bright regions of the two pictures, relative to a pre-selected threshold value, and the color difference is in the direction of the difference between the selected color of the additional illumination added in the picture capture of step 302 and the selected different color of the additional illumination added in the picture capture of step 304, then the processor can detect that the object being recorded is a three-dimensional object, and enable or confirm a face recognition task operated to verify an authorized user (step 310). The use of additional color in each picture capture (steps 302 and 304) can improve the robustness of the color analysis. A most robust analysis can be achieved if the two selected colors are well-separated, such as red and teal.

Otherwise, the processor can detect that the object being recorded is a two-dimensional image, and denies access to the smart phone (step 312).

In the first and second exemplary embodiments, two pictures were captured. To add even more robustness to the color analysis, multiple images, each with different colored additional illumination, can be captured and compared.

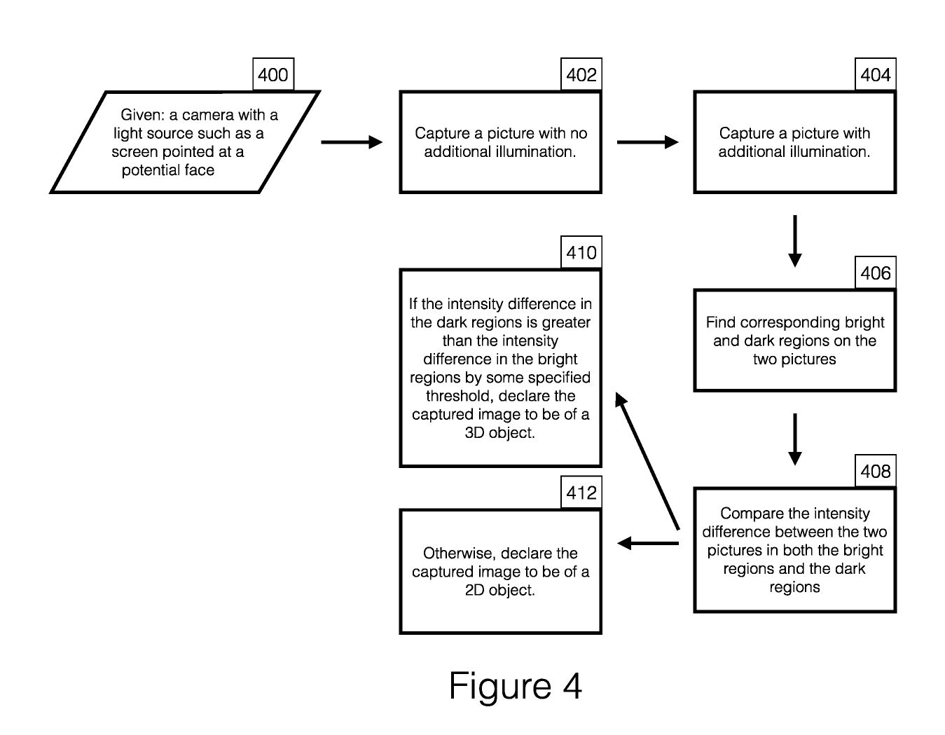

Referring now to FIG. 4, there is shown a flow chart for distinguishing a three-dimensional object from a two-dimensional image of the object, according to a third exemplary embodiment of the present invention. In the third exemplary embodiment of the present invention, an intensity analysis is performed in place of the color difference analysis, thus enabling the use of present invention when grayscale images are recorded by the electronic device.

As in the first exemplary embodiment, in step 400, the smart phone 100 is equipped with an on-board camera 101. Also as in the first exemplary embodiment of the present invention, a computer program is executed by a processor installed on the smart phone 100, to operate the on-board camera 101, to capture a first grayscale picture of an object presented as an authorized user with no additional illumination (step 402) and then capture a second grayscale picture of the same object with additional illumination, to increase the intensity of the illumination in the second picture (step 404).

Step 406 can be implemented as described above in respect to the first exemplary embodiment, to identify corresponding bright and dark regions in each of the first and second pictures, as a function of pixel intensity. Again, in the alternative, the processor can identify skin pixels and then identify corresponding dark and bright regions of the skin pixels.

Again, steps 408, 410 and 412 can be implemented as described in respect to the previous exemplary embodiments of the present invention, however, in the third exemplary embodiment, a color analysis is replaced by a pixel intensity analysis for the grayscale images recorded by the camera 101. Thus, if the difference in the intensity of the pixels in the dark region, as between the first and second pictures, is greater than the intensity difference in the bright region, by an amount greater than a pre-selected threshold, then the processor can detect that the object being recorded is a three-dimensional object, and enable or confirm a face recognition task operated to verify an authorized user. Otherwise, the processor can detect that the object being recorded is a two-dimensional image, and denies access to the smart phone.

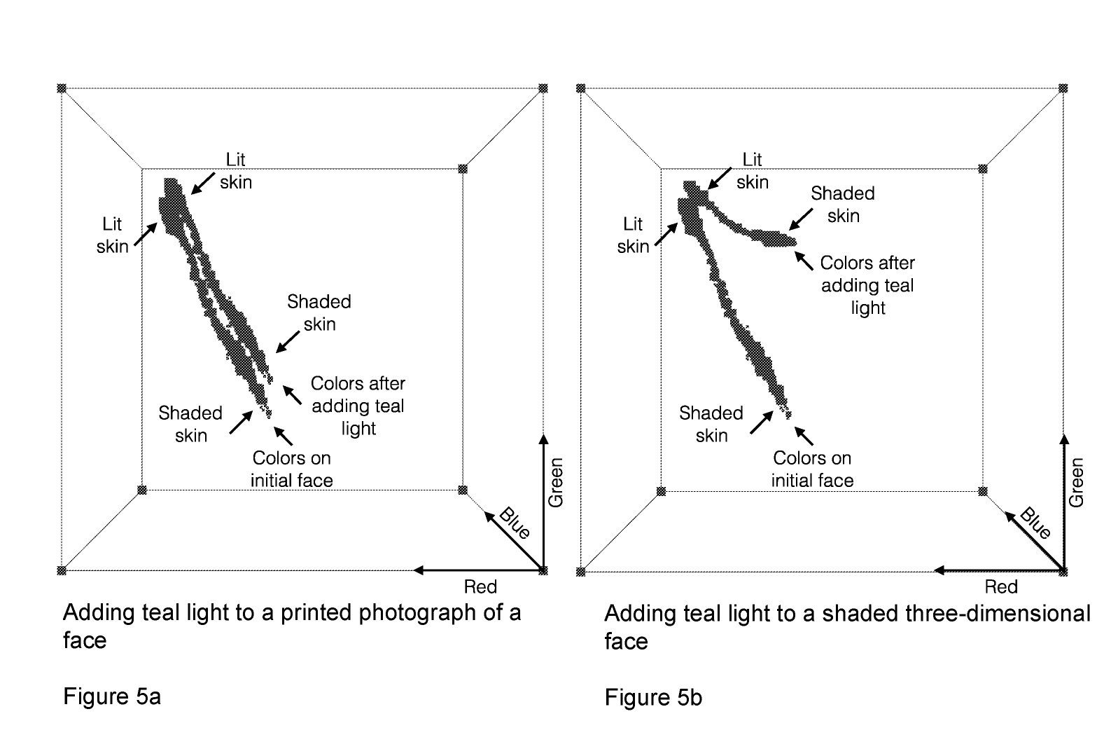

Referring now to FIG. 5a, there is shown a log RGB graph depicting color values of pixels for each of a first picture and a second picture of a two-dimensional object, for example a photograph of a face. In the three-dimensional RGB graph, each pixel of an identified skin surface of the face depicted in the photograph is assigned an appropriate three-dimensional coordinate in the space defined by log(R), log(G) and log(B) axes. As shown in the graph, the various colors from the bright lit skin areas, to the relatively darker shaded skin areas, roughly form a line in the RGB space. The two lines depicted in the graph of FIG. 5a correspond to the pixels of the first picture, or an initial image recorded by the camera 101, and the pixels of a second picture recorded by the camera 101, with a teal colored added illumination, as indicated in FIG. 5a.

As can be seen in the plotted pixel values shown in FIG. 5a, the first picture forms a first line. When a teal colored illumination is added in the second picture, the line corresponding to the second picture retains the same general length and orientation as the line corresponding to the first picture. However, the line corresponding to the second picture has translated towards the teal color, with the pixels for each of bright end and dark end of the line all moving approximately in the same direction.

As can be seen in the RGB graph of FIG. 5b, when the object being recorded by the camera 101 is a three-dimensional face, then the line corresponding to the second picture, recorded with a teal colored added illumination, changes in both length and orientation. The section of the second line corresponding to pixels in the bright skin of the face changes a relatively small amount toward teal, however, the section of the second line corresponding to pixels in the dark skin of the face changes significantly toward the teal color, and also the line section becomes relatively shorter in length.

As should be understood, a difference between pixel characteristics of a two-dimensional photograph of a face and a three-dimensional face, as clearly shown, for example, in FIGS. 5a and 5b, is utilized, according to the teachings of the present invention, to detect an image of a true three-dimensional face being processed for secure access to an electronic device. The difference is detected by analysis of at least two images of the same object, with differing illumination in each of the image captures. The different illumination can be of an added color or added intensity.

In the preceding specification, the invention has been described with reference to specific exemplary embodiments and examples thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. For use in an electronic device, an automated, computerized method for processing images of an object to detect a three-dimensional object, comprising the steps of:
using the device to capture multiple images of an object, with at least one of the captured images including added illumination of a selected color;
identifying pixels of the captured images corresponding to each of an identified shaded region and an identified lit region of the object;
comparing the pixels corresponding to the identified shaded and lit regions of the object from each of the multiple images, to each other, to determine a dark and lit region relative color difference; and
detecting a three-dimensional object in the images as a function of the dark and lit region relative color difference.

2. The method of claim 1 wherein the step of comparing the pixels corresponding to the identified shaded and lit regions of the object from each of the multiple images, to each other, to determine a dark and lit region relative color difference is carried out by comparing the pixels corresponding to the identified dark region of the object from each of the multiple images, to each other, to determine a dark region color difference, comparing the pixels corresponding to the identified lit region of the object from each of the multiple images, to each other, to determine a lit region color difference and analyzing a difference between the dark region color difference and the lit region color difference, relative to a threshold value.

3. The method of claim 1 including the additional step of utilizing a face recognition function to determine an authorized user as a function of when the detecting step indicates a three-dimensional object.

4. A computer program product, disposed on a non-transitory computer readable media, the product including computer executable process steps operable to control an electronic device processor to:
use the electronic device to capture multiple images of an object, with at least one of the captured images including added illumination of a selected color;
identify pixels of the captured images corresponding to each of an identified shaded region and an identified lit region of the object;
compare the pixels corresponding to the identified shaded and lit regions of the object from each of the multiple images, to each other, to determine a dark and lit region relative color difference; and
detect a three-dimensional object in the images as a function of the dark and lit region relative color difference.

5. The computer program product of claim 4 wherein the process step to compare the pixels corresponding to the identified shaded and lit regions of the object from each of the multiple images, to each other, to determine a dark and lit region relative color difference is carried out by comparing the pixels corresponding to the identified dark region of the object from each of the multiple images, to each other, to determine a dark region color difference, comparing the pixels corresponding to the identified lit region of the object from each of the multiple images, to each other, to determine a lit region color difference and analyzing a difference between the dark region color difference and the lit region color difference, relative to a threshold value.

6. The computer program product of claim 4 including the further process step to utilize a face recognition function to determine an authorized user as a function of when the process step to detect indicates a three-dimensional object.

7. For use in an electronic device, an automated, computerized method for processing images of an object to detect a three-dimensional object, comprising the steps of: capturing multiple images of an object having identified dark and lit regions, with at least one of the images being captured with added illumination, relative to others of the multiple images; and
detecting a three-dimensional object as a function of a difference between pixel characteristics of the multiple images relative to the identified dark and lit regions.

8. The method of claim 7 wherein the difference between pixel characteristics is a pixel color difference.

9. The method of claim 7 wherein the difference between pixel characteristics is a pixel intensity difference.
